(19) United States
(12) Patent Application Publication
(10) Pub. No.: US 2023/0326423 A1
(43) Pub. Date: Oct. 12, 2023

(54) LIQUID CRYSTAL DISPLAY, IMAGE DISPLAY PROCESSING METHOD AND RELATED DEVICE

(71) Applicant: TCL China Star Optoelectronics Technology Co., Ltd., Shenzhen City, Guangdong (CN)

(72) Inventor: Guanxian HE, Shenzhen, Guangdong (CN)

(21) Appl. No.: 17/781,001

(22) PCT Filed: Apr. 22, 2022
(86) PCT No.: PCT/CN2022/088592

§ 371 Date: May 30, 2022

(30) Foreign Application Priority Data
Apr. 7, 2022 (CA) 202210364867.X

(51) Int. Cl. G09G 3/36; G09G 3/20

(52) U.S. Cl. CPC G09G 3/3611; G09G 3/2007; G09G 2320/0626; G09G 2320/0233; G09G 2340/0407

(57) ABSTRACT

Disclosed is a liquid crystal display, an image display processing method, and a related device. The method includes receiving the first video image of the first display region; splitting the first video image into a first sub-video image and a second sub-video image according to a configuration type of the first display region; instructing the first timing control chip to display the first sub-video image and instructing the second timing control chip to display the second sub-video image.

### TECHNICAL FIELD

The present application relates to the technical field of image display processing, and in particular, to a liquid crystal display, an image display processing method and related device.

### BACKGROUND

At present, liquid crystal display panels with 8K (7680*4320) resolution is a matured technology and has been entered into mass production. The industry has started the development of ultra-high resolution technology with 16 K (15360*8640) resolution.

The existing 16 K-level liquid crystal display panel has such a peripheral driving system that is usually spliced, into 16 K resolution, by four individual driving systems with 8K resolution in a matrix of two rows by two columns. This makes an image display equivalent to a splicing display by four separate display panels rather than an image display on the entire LCD panel, resulting in a poor display of the LCD panel when the image display is performed.

### SUMMARY

### Technical Problems

Embodiments of the present application provide a liquid crystal display, an image display processing method, and a related device, which can display a video image after being split according to a configuration type of a display region of a display panel, thereby improving a display effect in displaying the video image.

### Solutions to Problems

### Technical Solutions

A first aspect of embodiments of the present application provides an image display processing method applied to a driving system of a display panel, the driving system comprising a first timing control chip and at least one second timing control chip, the display panel comprising a first display region for displaying a first video image, the method comprising:
receiving the first video image of the first display region;
splitting the first video image into a first sub-video image and at least one second sub-video image according to a configuration type of the first display region;
sending the first sub-video image to the first timing control chip to instruct the first timing control chip to display the first sub-video image, and sending the second sub-video image to a corresponding second timing control chip to instruct the corresponding second timing control chip to display a corresponding second sub-video image.

In conjunction with the first aspect, in a possible implementation, after the step of splitting the first video image into the first sub-video image and the at least one second sub-video image according to the configuration type of the first display region, the method further comprises:
determining a write-in address order of the first video image according to the configuration type of the first display region;
storing the first video image according to the write-in address order.

In conjunction with the first aspect, in one possible implementation, before the step of sending the first sub-video image to the first timing control chip or the step of sending the second sub-video image to the corresponding second timing control chip, the method further comprises:
acquiring a first property parameter of the first sub-video image or the second sub-video image;
adjusting a property parameter of the first sub-video image or the second sub-video image, if the first property parameter is lower than a preset property parameter.

In conjunction with the first aspect, in a possible implementation, before the step of sending the first sub-video image to the first timing control chip and sending the second sub-video image to the corresponding second timing control chip, the method further comprises:
acquiring a first charging direction of a driving circuit of the display panel corresponding to the first sub-video image, and a second charging direction of a driving circuit of the display panel corresponding to the second sub-video image;
adjusting a grayscale value of pixels in the first sub-video image to a target grayscale value according to the first charging direction;
adjusting a grayscale value of pixels in the second sub-video image to a target grayscale value according to the second charging direction.

In conjunction with the first aspect, in one possible implementation, the method further comprises:
receiving and acquiring a third sub-video image that is a video image, adjacent to the first video image, in a second video image of a second display region of the liquid crystal display panel;
determining a synchronization alignment parameter of a fourth sub-video image that is a video image in the first video image adjacent to the third sub-video image, according to the third sub-video image and the first video image;
processing the fourth sub-video image according to the synchronization alignment parameter to obtain a processed fourth sub-video image.

In conjunction with the first aspect, in one possible implementation, the driving system further comprises a third timing control chip and at least one fourth timing control chip, and the display panel further comprises at least one second display region for displaying a second video image; before the step of receiving the first video image of the first display region, the method further comprises:
receiving a video image and splitting the video image into the first video image and the second video image according to a configuration position of the first display region and the second display region.

The image display processing method further comprises:
receiving the second video image of the second display region;
splitting the second video image into a fifth sub-video image and at least one sixth sub-video image according to a configuration type of the second display region;
sending the fifth sub-video image to the third timing control chip to instruct the third timing control chip to display the fifth sub-video image, and sending the sixth sub-video image to a corresponding fourth timing control chip to instruct the corresponding fourth timing control chip to display a corresponding sixth sub-video image.

A second aspect of embodiments of the present application provides an image display processing apparatus applied to a driving system of a liquid crystal display panel, the driving system comprising a first timing control chip and at least one second timing control chip, the display panel comprising a first display region for displaying a first video image, the apparatus comprising:
a receiving unit configured to receive the first video image of the first display region;
a splitting unit configured to split the first video image into a first sub-video image and at least one second sub-video image according to a configuration type of the first display region;
a sending unit configured to send the first sub-video image to the first timing control chip to instruct the first timing control chip to display the first sub-video image, and to send the second sub-video image to a corresponding second timing control chip to instruct the corresponding second timing control chip to display a corresponding second sub-video image.

In conjunction with the second aspect, in one possible implementation, after the step of splitting the first video image into the first sub-video image and the at least one second sub-video image according to the configuration type of the first display region, the apparatus is further configured for:
determining a write-in address order of the first video image according to the configuration type of the first display region;
storing the first video image according to the write-in address order.

In conjunction with the second aspect, in one possible implementation, before the step of sending the first sub-video image to the first timing control chip or the step of sending the second sub-video image to the corresponding second timing control chip, the apparatus is further configured for

acquiring a first property parameter of the first sub-video image or the second sub-video image;

adjusting a property parameter of the first sub-video image or the second sub-video image, if the first property parameter is lower than a preset property parameter.

In conjunction with the second aspect, in one possible implementation, before the step of sending the first sub-video image to the first timing control chip and sending the second sub-video image to the corresponding second timing control chip, the apparatus is further configured for:
acquiring a first charging direction of a driving circuit of the display panel corresponding to the first sub-video image, and a second charging direction of a driving circuit of the display panel corresponding to the second sub-video image;
adjusting a grayscale value of pixels in the first sub-video image to a target grayscale value according to the first charging direction;
adjusting a grayscale value of pixels in the second sub-video image to a target grayscale value according to the second charging direction.

In conjunction with the second aspect, in one possible implementation, the apparatus is further configured for:
receiving and acquiring a third sub-video image that is a video image, adjacent to the first video image, in a second video image of a second display region of the liquid crystal display panel;
determining a synchronization alignment parameter of a fourth sub-video image that is a video image in the first video image adjacent to the third sub-video image, according to the third sub-video image and the first video image;
processing the fourth sub-video image according to the synchronization alignment parameter to obtain a processed fourth sub-video image.

In conjunction with the second aspect, in one possible implementation, the driving system further comprises a third timing control chip and at least one fourth timing control chip, and the display panel further comprises at least one second display region for displaying a second video image; before the step of receiving the first video image of the first display region, the apparatus is further configured for:
receiving a video image and splitting the video image into the first video image and the second video image according to a configuration position of the first display region and a second display region.

The image display processing apparatus is further configured for:
receiving the second video image of the second display region;
splitting the second video image into a fifth sub-video image and at least one sixth sub-video image according to a configuration type of the second display region;
sending the fifth sub-video image to the third timing control chip to instruct the third timing control chip to display the fifth sub-video image, and sending the sixth sub-video image to a corresponding fourth timing control chip to instruct the corresponding fourth timing control chip to display a corresponding sixth sub-video image.

A third aspect of embodiments of the present application provides a liquid crystal display comprising a display panel and a plurality of timing control chips.

The display panel is coupled to the plurality of timing control chips.

The display panel has a resolution of NK*MK, and a sum of resolutions of the plurality of timing control chips is equal to NK*MK, wherein N and M are positive integers.

The liquid crystal display is used to perform the method according to any one of the first aspects.

A fourth aspect of embodiments of the present application provides a computer-readable storage medium, wherein the computer-readable storage medium stores a computer program for electronic data exchange. The computer program allows a computer to perform some or all of the steps described in the first aspect of embodiments of the present application.

A fifth aspect of embodiments of the present application provides a computer program product, wherein the computer program product comprises a non-transitory computer-readable storage medium storing a computer program operable to allow a computer to perform some or all of the steps described in the first aspect of embodiments of the present application. The computer program product may be a software installation package.

### BENEFICIAL EFFECTS OF THE INVENTION

### Beneficial Effects

Carrying out the embodiments of the present application has at least the following advantages:

By receiving the first video image of the first display region, splitting the first video image into the first sub-video image and at least one second sub-video image according to a configuration type of the first display region, sending the first sub-video image to the first timing control chip to instruct the first timing control chip to display the first sub-video image, and sending the second sub-video image to a corresponding second timing control chip to instruct the corresponding second timing control chip to display a corresponding second sub-video image, the video image can be split according to the configuration type of the display region of the display panel, and the first sub-video image and the at least one second sub-video image can be obtained and displayed, thereby improving a display effect when displaying the video image.

### BRIEF DESCRIPTION OF THE DRAWINGS

### Description of the Drawings

In order to more clearly describe the technical solutions in the embodiments of the present application or the prior art, accompanying drawings required in the description of the embodiments or the prior art will be briefly described below. Obviously, the accompanying drawings in the following description are merely some embodiments of the present application, and other drawings may be obtained by a person of ordinary skill in the art without creative efforts.

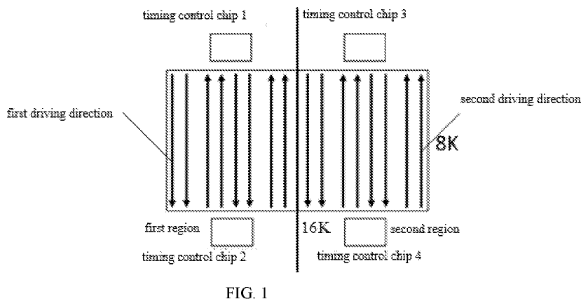

FIG. 1 is a schematic view of a driving panel according to an embodiment of the present application.

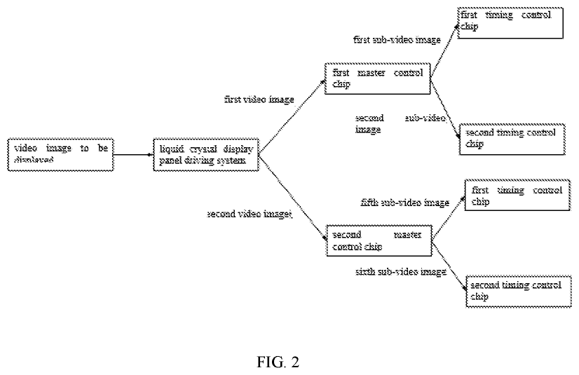

FIG. 2 is a schematic diagram of an image display processing method according to an embodiment of the present application.

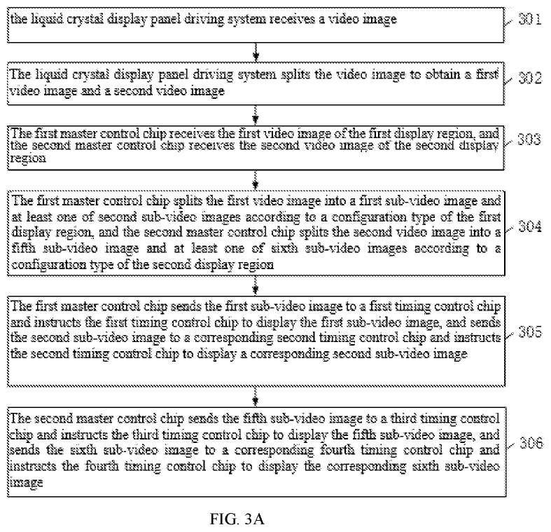

FIG. 3A is a schematic flowchart of an image display processing method according to an embodiment of the present application;

FIG. 3B is a schematic view of configuration types according to an embodiment of the present application.

FIG. 3C is a schematic diagram of a relationship between a charging direction and a charging quality according to an embodiment of the present application.

FIG. 3D is a schematic diagram of writing video data according to an embodiment of the present application.

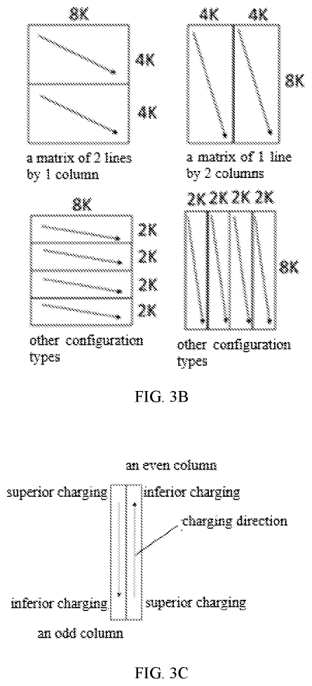

FIG. 4 is a schematic structural view of a liquid crystal display according to an embodiment of the present application.

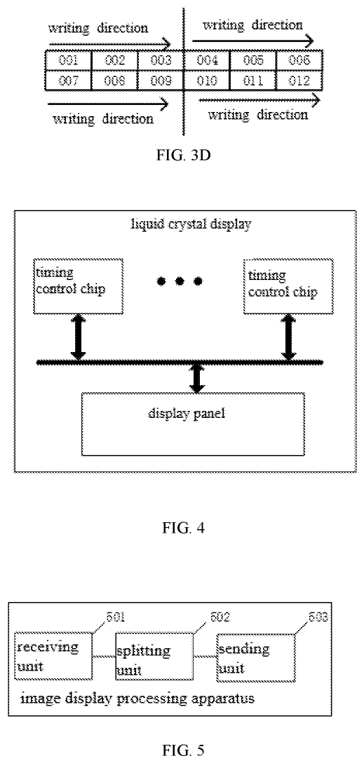

FIG. 5 is a schematic structural view of an image display processing apparatus according to an embodiment of the present application.

### EMBODIMENTS OF THE INVENTION

### Implementations of the Invention

Technical solutions in embodiments of the present application will be clearly and completely described below in conjunction with drawings in the embodiments of the present application. Obviously, the described embodiments are only a part of embodiments of the present application, rather than all the embodiments. Based on the embodiments in the present application, all other embodiments obtained by those skilled in the art without creative work fall within the protection scope of the present application.

The terms “first”, “second”, etc. in the specification and claims and in the accompanying drawings above of the present application are used to distinguish between different objects and are not intended to describe a particular order. In addition, the terms “comprising”, “comprise”, “including”, “includes”, “having”, “have”, and any variations thereof, are intended to cover non-exclusive inclusion. For example, a process, method, system, product or apparatus comprising a series of steps or units is not limited to the listed steps or units, but optionally includes steps or units that are not listed, or optionally includes other steps or units that are inherent to those processes, methods, products or apparatus.

References to “embodiments” in the present application mean that particular features, structures, or characteristics described in connection with an embodiment may be included in at least one embodiment of the present application. The occurrence of the phrase at various points in the specification does not necessarily mean the same embodiment, nor is it a separate or alternative embodiment that is mutually exclusive with other embodiments. It is understood, both explicitly and implicitly, by those of skill in the art that the embodiments described in the present application may be combined with other embodiments.

In order to better understand an image display processing method of the embodiments of the present application, the following briefly describes a driving panel of a liquid crystal display panel driving system to which the image display processing method is applied. Referring to FIG. 1, it is a schematic view of a driving panel according to an embodiment of the present application. As shown in FIG. 1, the driving panel drives a liquid crystal display panel, wherein the driving panel has a first region corresponding to a first display region of the liquid crystal display panel, a second region corresponding to a second display region of the liquid crystal display panel, and the liquid crystal display panel has a resolution of 16 K*8K. There are two different driving directions in the driving panel, and the driving directions can be understood as charging directions of a data driving circuit. A driving system of a liquid crystal display panel corresponding to the driving panel comprises 2 master control chips (not shown) and 4 timing control chips, and each of the display regions corresponds to one of the master control chips. For example, a first master control chip corresponds to the first display region for processing a first video image of the first display region, and a second master control chip corresponds to the second display region for processing a second video image of the second display region. Each of the master control chips corresponds to 2 timing control chips. The first display region herein corresponds to a first timing control chip and a second timing control chip (shown as a timing control chip 1 and a timing control chip 2), and the second display region corresponds to a third timing control chip and a fourth timing control chip (shown as a timing control chip 3 and a timing control chip 4). The first timing control chip drives pixels in odd columns in the first display region, and the second timing control chip drives pixels in even columns in the first display region, thereby displaying the first video image in the first display region. Similarly, the second display region is driven in a same manner as the first display region. It will be appreciated that, in other embodiments, the first display region and the second display region may be controlled by a same master control chip for displaying.

Referring specifically to FIG. 2, it is a schematic diagram of an image display processing method according to an embodiment of the present application. As shown in FIG. 2, the method is applied to a driving system of a liquid crystal display panel, which comprises a first master control chip for processing a first video image of a first display region of the liquid crystal display panel, and a second master control chip for processing a first video image of a second display region of the liquid crystal display panel. Specifically, a video image to be displayed is received and split by the driving system of liquid crystal display panel into a first video image and a second video image. The first master control chip receives the first video image of the first display region, and the second master control chip receives the second video image of the second display region. The first master control chip splits the first video image into a first sub-video image and a second sub-video image according to a configuration type of the first display region corresponding to the first video image, and the second master control chip splits the second video image into a fifth sub-video image and a sixth sub-video image according to a configuration type of the second display region corresponding to the second video image. The first master control chip sends the first sub-video image to a first timing control chip, and instructs the first timing control chip to display the first sub-video image. The first master control chip sends the second sub-video image to a second timing control chip, and instructs the second timing control chip to display the second sub-video image. The second master control chip sends the fifth sub-video image to a third timing control chip, and instructs the third timing control chip to display the fifth sub-video image. The second master control chip sends the sixth sub-video image to a fourth timing control chip, and instructs the fourth timing control chip to display the sixth sub-video image. Thus, driving of upper-and-lower cross bidirectional driving panels is realized, thereby avoiding a driving scheme of an individual liquid crystal display panel with ultra-large size and ultra-high resolution and improving display effect.

Referring to FIG. 3A, it is a schematic flowchart of an image display processing method according to an embodiment of the present application. As shown in FIG. 3A, the method is applied to a driving system of liquid crystal display panel, which comprises a first master control chip for processing a first video image of a first display region of the liquid crystal display panel, and a second master control chip for processing a second video image of a second display region of the liquid crystal display panel. The system further comprises a first timing control chip, at least one second timing control chip, a third timing control chip, and at least one fourth timing control chip. The method comprises the following steps:

301. the driving system of liquid crystal display panel receives a video image.

The video image may be any video image required for displaying, and have a property parameter lower than or equal to a preset property parameter. The property parameter includes a resolution or the like. Certainly, the property parameter may also be a property parameter of a video, for example, a refresh rate of the video. The preset property parameter may be set by empirical values or historical data. For example, the resolution may be 16 K*8K, the refresh rate may be 60 Hz, etc., which are only illustrative and not specifically limited here.

Specifically, the driving system of liquid crystal display panel receives a video to be displayed, acquires a video image, including a property parameter thereof, from the video to be displayed. The property parameter includes a property parameter of images and a property parameter of videos, for example, a resolution of images, a refresh rate of videos, or the like.

302. The driving system of liquid crystal display panel splits the video image to obtain a first video image and a second video image.

The driving system of liquid crystal display panel may split the video image according to a position and shape of the display region of the liquid crystal display panel. For example, where the first display region is arranged in parallel with the second display region from left to right, the video image to be displayed is split according to shapes of the first and second display regions, so as to obtain the first video image and the second video image that are in parallel from left to right. For another example, where the first display region is arranged in parallel with the second display region from upper to lower, the video image to be displayed is split according to shapes of the first and second display regions, so as to obtain the first video image and the second video image that are in parallel from upper to lower. Certainly, it is also possible to split the video image to be displayed by other means, which are not specifically limited here.

The driving system of liquid crystal display panel may input the first video image and the second video image to a corresponding first master control chip and second master control chip respectively through a 64-way VBO high-speed interface.

303. The first master control chip receives the first video image of the first display region, and the second master control chip receives the second video image of the second display region.

The first master control chip may receive the first video image of the first display region through a 64-way VBO high-speed interface, and the second master control chip may receive the second video image of the second display region through a 64-way VBO high-speed interface.

304. The first master control chip splits the first video image into a first sub-video image and at least one second sub-video image according to a configuration type of the first display region, and the second master control chip splits the second video image into a fifth sub-video image and at least one sixth sub-video image according to a configuration type of the second display region.

The configuration type of the first display region may include a matrix of 2 lines by 1 column, a matrix of 1 line by 2 columns, or other configurations. In particular, reference may be made to FIG. 3B, which shows a matrix of 2 lines by 1 column, a matrix of 1 line by 2 columns, or other configuration types (e.g., a matrix of n lines by 1 column, or a matrix of 1 line by n columns)

Different configuration types correspond to different splitting modes, and the split first and second sub-video images are matched with a configuration type. For example, in the matrix of 2 lines by 1 column, the first sub-video image and the second sub-video image are vertically parallel video images. The first video image is split into such a number that may be equal to the number of data driving circuits in the driving panel in a vertical direction (the number in the vertical direction may be understood as a number of individual driving circuits in the vertical direction, specifically, the number of individual driving circuits from upper to lower, for example), wherein the first sub-video image may be a sub-video image in odd columns, and the at least one second sub-video image may be a sub-video image in even columns.

Certainly, after the first video image is split, the obtained first sub-video image and second sub-video image may also be processed. For example, property parameters of the first sub-video image and second sub-video image are processed, or gray-scale values of pixels in the first sub-video image and second sub-video image are adjusted.

The method of processing the second video image by the second master control chip is the same as the method of processing the first video image by the first master control chip.

305. The first master control chip sends the first sub-video image to a first timing control chip and instructs the first timing control chip to display the first sub-video image, and sends the second sub-video image to a corresponding second timing control chip and instructs the second timing control chip to display a corresponding second sub-video image.

The first master control chip may send the first sub-video image to the first timing control chip through a 32-way VBO high-speed interface.

After receiving the first sub-video image, the first timing control chip displays the first sub-video image by driving corresponding pixels. The method of displaying the second sub-video image by the second timing control chip is the same as the method of displaying the first sub-video image by the first timing control chip.

306. The second master control chip sends the fifth sub-video image to a third timing control chip and instructs the third timing control chip to display the fifth sub-video image, and sends the sixth sub-video image to a corresponding fourth timing control chip and instructs the fourth timing control chip to display the corresponding sixth sub-video image.

After receiving the fifth sub-video image, the third timing control chip displays the fifth sub-video image by driving corresponding pixels. The method of displaying the sixth sub-video image by the fourth timing control chip is the same as the method of displaying the fifth sub-video image by the third timing control chip.

In this example, the driving system of liquid crystal display panel splits the received video image to obtain the first video image and the second video image, and the first video image is split into the first and second sub-video images by the first master control chip according to the configuration type of the first display region, the second video image is split into the fifth and sixth sub-video images by the second master control chip according to the configuration type of the second display region. The first master control chip sends the first sub-video image to the first timing control chip and instructs the first timing control chip to display the first sub-video image, and sends the second sub-video image to a corresponding second timing control chip and instructs the second timing control chip to display a corresponding second sub-video image. The second master control chip sends the fifth sub-video image to the third timing control chip and instructs the third timing control chip to display the fifth sub-video image, and sends the sixth sub-video image to a corresponding fourth timing control chip and instructs the fourth timing control chip to display a corresponding sixth sub-video image. Therefore, the video image may be split according to the configuration type of the display region, so that the first sub-video image and the second sub-video image are obtained and displayed, thereby improving display effect of the video images.

In a possible implementation, before the step of sending the first sub-video image to the first timing control chip or the step of sending the second sub-video image to the corresponding second timing control chip, the property parameter of the first sub-video image or the second sub-video image may be further adjusted, wherein the method comprises:
A1. the first master control chip acquires a first property parameter of the first sub-video image or the second sub-video image;
A2. if the first property parameter is lower than a preset property parameter, the first master control chip adjusts the property parameter of the first sub-video image or the second sub-video image.

The first property parameter may include a resolution and the like. The preset property parameter may be set with reference to the preset property parameters in the foregoing embodiments, and details are not described herein again. For example, if the first property parameter is a resolution of 8K*4K, a resolution may be enlarged to obtain a preset resolution of 16 K*8K.

The property parameter of the first sub-video image or the second sub-video image may be adjusted to a preset property parameter or another parameter higher than the first property parameter.

In this example, when the first property parameter is lower than the preset property parameter, the property parameter of the first sub-video image or the second sub-video image is adjusted, thereby further improving display effect of the video image.

In a possible implementation, before the step of sending the first sub-video image to the first timing control chip and sending the second sub-video image to the corresponding second timing control chip, a grayscale value of pixels in the first sub-video image may further be adjusted to reduce a phenomenon of bright and dark lines of the liquid crystal display panel when displaying, thereby improving display effect, wherein the method specifically comprises:
B1. the first master control chip acquires a first charging direction of a driving circuit of the liquid crystal display panel corresponding to the first sub-video image, and a second charging direction of a driving circuit of the display panel corresponding to the second sub-video image;
B2: the first master control chip adjusts a grayscale value of pixels in the first sub-video image to a target grayscale value according to the first charging direction;
B3. the first master control chip adjusts a grayscale value of pixels in the second sub-video image to a target grayscale value according to the second charging direction.

The target grayscale value of pixels may be determined according to a relationship between a charging direction and a charging quality. After the target grayscale value is determined, the grayscale value of pixels in the first sub-video image may be adjusted to the target grayscale value, and the grayscale value of pixels in the second sub-video image may be adjusted to the target grayscale value. As shown in FIG. 3C, it shows a schematic diagram of a relationship between the charging direction and the charging quality. The closer the pixels are to a superior charging, the lower the target grayscale value is relative to the original grayscale value of pixels, and the closer the pixels are to an inferior charging, the higher the target grayscale value is relative to the original grayscale value of pixels.

With respect to a panel architecture with the upper-and-lower cross bidirectional driving, data lines in the odd and even columns are driven from the upper and lower sides of the panel respectively, so that in the case of oversized panels, the impedance and parasitic capacitance on the data lines are relatively large, and data lines on a side far from the data driving circuit will have a less charging effect than data lines on a side close to the data driving circuit, resulting in a phenomenon of bright and dark lines in the odd and even columns on the upper and lower sides of the panel. Therefore, the driving system of the present application may add a corresponding charging compensation algorithm, so as to determine a charging direction of the data driving circuit for each column of pixels, change a display grayscale value of each column of pixels, including increase of the grayscale value in the undercharged region and reduction of the grayscale value in the overcharged region, thereby resulting in uniformly charging of the panel, reducing the phenomenon of bright and dark lines in the odd and even columns, and enhancing display effect of the image.

In a possible implementation, video alignment may further be performed between the first master control chip and the second master control chip to ensure data continuity, specifically as follows:
C1. the first master control chip receives and acquires a third sub-video image that is a video image, adjacent to the first video image, in the second video image of the second display region of the liquid crystal display panel;
C2. the first master control chip determines a synchronization alignment parameter of a fourth sub-video image according to the third sub-video image and the first video image, wherein the fourth sub-video image is a video image of the first video image adjacent to the third sub-video image;
C3. the first master control chip processes the fourth sub-video image according to the synchronization alignment parameters to obtain a processed fourth sub-video image.

The third sub-video image may be a preset number of fifth sub-video images and sixth sub-video images.

By processing the fourth sub-video image with the synchronization alignment parameter to obtain the processed fourth sub-video image, it is possible to align the videos in the two master control chips to guarantee synchronization, while ensuring data continuity at an interface between a left image and a right image in the subsequent image processing, thereby avoiding the image being split into two discontinuous images from left to right, and improving the display effect.

The synchronization alignment parameter may be a presentation time stamp. Since the split images are the split video images, the split images may be spliced at positions of splicing and connecting, so as to obtain a video image. Therefore, the synchronization processing may be performed by synchronizing the presentation time stamp. One possible method for processing the fourth sub-video image by synchronizing the alignment parameter may be performed by adjusting a presentation time stamp of the fourth sub-video image to the presentation time stamp to synchronize the presentation time, thereby realizing the processing of the fourth sub-video image.

Certainly, a synchronization alignment parameter of the third sub-video image may be further determined according to the third sub-video image and the first video image, and the third sub-video image may be processed according to the synchronization alignment parameters of the third sub-video image to obtain the processed third sub-video image. The specific processing method may refer to the method of processing the fourth sub-video image in the foregoing embodiment.

In a possible implementation, the first master control chip may further store the first video image, specifically comprising:
D1. determining a write-in address order of the first video image according to a configuration type of the first display region;
D2. storing the first video image according to the write-in address order.

There are different write-in address orders according to different configuration types. For example, for half-screens with the matrix of n lines by one column, a write-in address of the upper half region starts from 0 and ends at half of the last address of one frame, and a write-in address of the lower half region starts from half of the last address of one frame and ends at the last address of one frame. For another example, for half-screens with the matrix of one line by n columns, a write-in address of the left half region starts from 0, and jumps to the beginning of the next line when reaching half of a line, until half of the last line; a write-in address of the right half region starts from half of the first line, jumps to half of the next line when reaching the end of a line, until the last address of one frame. Certainly, it is possible to perform another write mode, and this is merely an example here.

In a specific example, a half-screen with the matrix of one line and n columns is illustrated in conjunction with FIG. 3D, for example, having an address as:

001/002/003/004/005/006;

007/008/009/010/011/012.

The write order of the first video image is 001/002/003/007/008/009

The write order of the second video image is 004/005/006/010/011/012.

Data reading may start from address 0 and increase sequentially to the last address of one frame.

In this example, storing is performed according to the write-in address order, and subsequent reading starts at address 0 and increases sequentially to the last address of one frame. Therefore, it is possible to perform screen partitioning of the video image and improve convenience.

Consistent with the above embodiments, referring to FIG. 4, it is a schematic structural view of a liquid crystal display according to an embodiment of the present application, comprising a display panel and a plurality of timing control chips.

The display panel are coupled to the plurality of timing control chips.

The display panel has a resolution of NK*MK, and a sum of resolutions of the plurality of timing control chips is equal to NK*MK, wherein N and M are positive integers.

The liquid crystal display is used to perform the method as described in the foregoing embodiments.

The above-described solutions of the embodiments of the present application are illustrated mainly from the viewpoint of methods for performing a process. It will be appreciated that in order to implement the above-described functions, the terminal comprises hardware structures and/or software modules that perform the respective functions. Those skilled in the art should readily appreciate that, the present application can be implemented in a form of hardware or a combination of hardware and computer software, in combination with the unit and algorithm steps of the examples described in the embodiments provided herein. Whether a function is executed in the form of hardware or computer software driving hardware depends on the particular application and design constraints in the technical solutions. Those skilled in the art may use different methods for each particular application to implement the described functions, but such implementation should not be considered beyond the scope of the present application.

In the embodiments of the present application, the terminal may be divided into functional units according to the above method examples. For example, it is possible to divide the terminal into respective functional unit corresponding to each function, or to gather two or more functions in one processing unit. The gathered unit may be realized in the form of hardware or software functional unit. It should be noted that the division of the units in the embodiments of the present application is illustrative, and is only a logical function division. There may be another division mode in actual implementation.

Consistent with the above, referring to FIG. 5, it is a schematic structural view of an image display processing apparatus according to an embodiment of the present application. As shown in FIG. 5, the image display processing apparatus is applied to a driving system of liquid crystal display panel comprising a first timing control chip and at least one second timing control chip, and the display panel comprises a first display region for displaying a first video image, wherein the apparatus comprises:
a receiving unit 501 for receiving the first video image of the first display region;
a splitting unit 502 for splitting the first video image into a first sub-video image and a second sub-video image according to a configuration type of the first display region;
a sending unit 503 for sending the first sub-video image to a first timing control chip to instruct the first timing control chip to display the first sub-video image, and for sending the second sub-video image to a corresponding second timing control chip to instruct the corresponding second timing control chip to display the corresponding second sub-video image.

In a possible implementation, after the step of splitting the first video image into the first sub-video image and the at least one second sub-video image according to the configuration type of the first display region, the apparatus is used for:
determining a write-in address order of the first video image according to a configuration type of the first display region;
storing the first video image according to the write-in address order.

In a possible implementation, before the step of sending the first sub-video image to the first timing control chip or the step of sending the second sub-video image to the corresponding second timing control chip, the apparatus is further used for:
acquiring a first property parameter of the first sub-video image or the second sub-video image;
adjusting the property parameter of the first sub-video image or the second sub-video image if the first property parameter is lower than a preset property parameter.

In a possible implementation, before the step of sending the first sub-video image to the first timing control chip and sending the second sub-video image to the corresponding second timing control chip, the apparatus is further used for:
acquiring a first charging direction of a driving circuit of a display panel corresponding to the first sub-video image and a second charging direction of a driving circuit of a display panel corresponding to the second sub-video image;
adjusting a grayscale value of pixels in the first sub-video image to a target grayscale value according to the first charging direction;
adjusting a grayscale value of pixels in the second sub-video image to a target grayscale value according to the second charging direction.

In a possible implementation, the apparatus is further used for:
receiving and acquiring a third sub-video image that is a video image, adjacent to the first video image, in the second video image of the second display region of the liquid crystal display panel;
determining a synchronization alignment parameter of a fourth sub-video image that is a video image of the first video image adjacent to the third sub-video image, according to the third sub-video image and the first video image;
processing the fourth sub-video image according to the synchronization alignment parameter to obtain a processed fourth sub-video image.

In a possible implementation, the driving system of display panel further comprises a third timing control chip and at least one fourth timing control chip. The display panel further comprises at least one second display region for displaying a second video image. Before the step of receiving the first video image of the first display region, the apparatus is further used for:

receiving a video image, and splitting the video image into a first video image and a second video image according to configuration positions of the first display region and the second display region;
The image display processing apparatus is further used for:
receiving a second video image of the second display region;
splitting the second video image into a fifth sub-video image and at least one sixth sub-video image according to a configuration type of the second display region;
sending the fifth sub-video image to a third timing control chip and instructing the third timing control chip to display the fifth sub-video image, and sending the sixth sub-video image to a corresponding fourth timing control chip and instructing the fourth timing control chip to display the corresponding sixth sub-video image.

Embodiments of the present application further provide a computer storage medium that stores a computer program for electronic data exchange, wherein the computer program allows a computer to perform some or all of the steps of any of the image display processing methods described in the above-described method embodiments.

Embodiments of the present application further provide a computer program product that comprises a non-transitory computer-readable storage medium storing a computer program, wherein the computer program allows a computer to perform some or all of the steps of any of the image display processing methods described in the above-described method embodiments.

It should be noted that, for the sake of brief description, the foregoing method embodiments are described as a combination of a series of actions, but those skilled in the art should appreciate that the present application is not limited to the described action sequences, and some steps may be performed in other sequences or simultaneously according to the present application. In addition, those skilled in the art should also appreciate that the embodiments described in the specification are all preferred embodiments, and that the actions and modules involved are not necessarily required by the present application.

In the above-described embodiments, the description of each embodiment has its own focus, and for a part not described in detail in some embodiments, reference may be made to the related description of other embodiments.

In the embodiments provided herein, it should be appreciated that the disclosed apparatus may be implemented in other ways. For example, the device embodiments described above are merely illustrative, such as the division of the units, which is merely a logical functional division, and may be implemented in another way, for example, multiple units or components may be combined or integrated into another system, or some features may be ignored or not performed. Alternatively, coupling shown or discussed, such as direct coupling or communication connection, may be performed through interfaces, or indirect coupling or communication connection of devices or units may be in electrical or other forms.

The units described as separate elements may or may not be physically separated, and the elements shown as units may or may not be physical units, i.e. may be located in one place, or may be distributed over a plurality of network units. Part or all of the units may be selected according to actual needs to achieve the purpose of the solution of this embodiment.

In addition, it is indicated in the present application that all of functional units in each embodiment may be integrated into one processing unit, or each unit may be physically separated, or two or more units may be integrated into one unit. The integrated unit may be implemented in the form of hardware or software program module.

If the integrated unit is implemented in the form of the software program module, and sold or used as a stand-alone product, it may be stored in a computer readable memory. Based on such an understanding, in the present application, part of the technical solutions which essentially contributes to the prior art, or all or part of the technical solutions may be embodied in the form of a software product stored in a memory, including instructions to allow a computer device (which may be a personal computer, a server or a network device, etc.) to perform all or part of the steps of the methods described in the various embodiments of the present application. The memory includes a USB flash drive, a read-only memory (ROM), a random access memory (RAM), a mobile hard disk, a diskette, an optical disk, or any other medium that can store program code.

It will be appreciated by those of ordinary skill in the art that all or some of the steps of the various methods of the embodiments described above may be accomplished by instructing the relevant hardware through a program that may be stored in a computer-readable memory, including a flash memory, a read-only memory, a random access memory, a magnetic disk or an optical disk, or the like.

The above embodiments of the present application are described in detail. The principles and implementation of the present application are described by specific examples. The description of the above embodiments is only used to help understand the method and core idea of the present application. According to the idea of the present application, there will be some changes in the specific embodiments and application scope to those skilled in the art. In conclusion, the contents of the present specification shall not be construed as limiting the present application.

1. An image display processing method applied to a driving system of a display panel, the driving system comprising a first timing control chip and a second timing control chip, the display panel comprising a first display region for displaying a first video image, the method comprising:
receiving the first video image of the first display region;
splitting the first video image into a first sub-video image and a second sub-video image according to a configuration type of the first display region;
sending the first sub-video image to the first timing control chip to instruct the first timing control chip to display the first sub-video image, and sending the second sub-video image to the second timing control chip to instruct the second timing control chip to display the second sub-video image,
wherein the first sub-video image is a sub-video image in odd columns, and the second sub-video image is a sub-video image in even columns,
wherein before the step of sending the first sub-video image to the first timing control chip and sending the second sub-video image to the second timing control chip, the method further comprises:
acquiring a first charging direction of a driving circuit of the display panel corresponding to the first sub-video image, and a second charging direction of a driving circuit of the display panel corresponding to the second sub-video image;
adjusting a grayscale value of pixels in the first sub-video image to a target grayscale value according to the first charging direction;
adjusting a grayscale value of pixels in the second sub-video image to a target grayscale value according to the second charging direction.

2. The method of claim 1, wherein after the step of splitting the first video image into the first sub-video image and the second sub-video image according to the configuration type of the first display region, the method further comprises:
determining a write-in address order of the first video image according to the configuration type of the first display region;
storing the first video image according to the write-in address order.

3. The method of claim 1, wherein before the step of sending the first sub-video image to the first timing control chip or the step of sending the second sub-video image to the second timing control chip, the method further comprises:
acquiring a first property parameter of the first sub-video image or the second sub-video image;
adjusting a property parameter of the first sub-video image or the second sub-video image, if the first property parameter is lower than a preset property parameter.

4. The method of claim 2, wherein before the step of sending the first sub-video image to the first timing control chip or the step of sending the second sub-video image to the second timing control chip, the method further comprises:
acquiring a first property parameter of the first sub-video image or the second sub-video image;
adjusting a property parameter of the first sub-video image or the second sub-video image, if the first property parameter is lower than a preset property parameter.

5. (canceled)

6. The method of claim 1, wherein the method further comprises:
receiving and acquiring a third sub-video image that is a video image, adjacent to the first video image, in a second video image of a second display region of the display panel;
determining a synchronization alignment parameter of a fourth sub-video image that is a video image in the first video image adjacent to the third sub-video image, according to the third sub-video image and the first video image;
processing the third sub-video image or the fourth sub-video image according to the synchronization alignment parameter to obtain a processed fourth sub-video image.

7. The method of claim 1, wherein the driving system of the display panel further comprises a third timing control chip and at least one fourth timing control chip, and the display panel further comprises at least one second display region for displaying a second video image; before the step of receiving the first video image of the first display region, the method further comprises:
receiving a video image and splitting the video image into the first video image and the second video image according to a configuration position of the first display region and the second display region;
wherein the image display processing method further comprises:
receiving the second video image of the second display region;
splitting the second video image into a fifth sub-video image and at least one sixth sub-video image according to a configuration type of the second display region;
sending the fifth sub-video image to the third timing control chip to instruct the third timing control chip to display the fifth sub-video image, and sending the sixth sub-video image to a corresponding fourth timing control chip to instruct the corresponding fourth timing control chip to display a corresponding sixth sub-video image.

8. An image display processing apparatus applied to a driving system of a liquid crystal display panel, the driving system comprising a first timing control chip and at least one a second timing control chip, the display panel comprising a first display region for displaying a first video image, the apparatus comprising:
a receiving unit configured to receive the first video image of the first display region;
a splitting unit configured to split the first video image into a first sub-video image and a second sub-video image according to a configuration type of the first display region;
a sending unit configured to send the first sub-video image to the first timing control chip to instruct the first timing control chip to display the first sub-video image, and to send the second sub-video image to the second timing control chip to instruct the second timing control chip to display the second sub-video image,
wherein the first sub-video image is a sub-video image in odd columns, and the second sub-video image is a sub-video image in even columns,
wherein before the step of sending the first sub-video image to the first timing control chip and sending the second sub-video image to the second timing control chip, the apparatus is further configured for:
acquiring a first charging direction of a driving circuit of the display panel corresponding to the first sub-video image, and a second charging direction of a driving circuit of the display panel corresponding to the second sub-video image;
adjusting a grayscale value of pixels in the first sub-video image to a target grayscale value according to the first charging direction;
adjusting a grayscale value of pixels in the second sub-video image to a target grayscale value according to the second charging direction.

9. The apparatus of claim 8, wherein after the step of splitting the first video image into the first sub-video image and the second sub-video image according to the configuration type of the first display region, the apparatus is further configured for:
determining a write-in address order of the first video image according to the configuration type of the first display region;
storing the first video image according to the write-in address order.

10. The apparatus of claim 8, wherein before the step of sending the first sub-video image to the first timing control chip or the step of sending the second sub-video image to the second timing control chip, the apparatus is further configured for:
acquiring a first property parameter of the first sub-video image or the second sub-video image;
adjusting a property parameter of the first sub-video image or the second sub-video image, if the first property parameter is lower than a preset property parameter.

11. The apparatus of claim 9, wherein before the step of sending the first sub-video image to the first timing control chip or the step of sending the second sub-video image to the second timing control chip, the apparatus is further configured for:
acquiring a first property parameter of the first sub-video image or the second sub-video image;
adjusting a property parameter of the first sub-video image or the second sub-video image, if the first property parameter is lower than a preset property parameter.

12. (canceled)

13. The apparatus of claim 8, wherein the apparatus is further configured for:
receiving and acquiring a third sub-video image that is a video image, adjacent to the first video image, in a second video image of a second display region of the display panel;
determining a synchronization alignment parameter of a fourth sub-video image that is a video image in the first video image adjacent to the third sub-video image, according to the third sub-video image and the first video image;
processing the third sub-video image or the fourth sub-video image according to the synchronization alignment parameter to obtain a processed fourth sub-video image.

14. The apparatus of claim 8, wherein the driving system further comprises a third timing control chip and at least one fourth timing control chip, and the display panel further comprises at least one second display region for displaying a second video image; before the step of receiving the first video image of the first display region, the apparatus is further configured for:
receiving a video image and splitting the video image into the first video image and the second video image according to a configuration position of the first display region and a second display region;
wherein the image display processing method further comprises:
receiving the second video image of the second display region;
splitting the second video image into a fifth sub-video image and at least one sixth sub-video image according to a configuration type of the second display region;
sending the fifth sub-video image to the third timing control chip to instruct the third timing control chip to display the fifth sub-video image, and sending the sixth sub-video image to a corresponding fourth timing control chip to instruct the corresponding fourth timing control chip to display a corresponding sixth sub-video image.

15. A liquid crystal display comprising a display panel and a plurality of timing control chips,
wherein the display panel is coupled to the plurality of timing control chips;
the display panel has a resolution of NK*MK, and a sum of resolutions of the plurality of timing control chips is equal to NK*MK, wherein N and M are positive integers;
the liquid crystal display is used to perform an image processing method,
the image processing method is applied to a driving system of the display panel, the driving system comprising a first timing control chip and a second timing control chip, the display panel comprises a first display region for displaying a first video image, and the method comprises:
receiving the first video image of the first display region;
splitting the first video image into a first sub-video image and at least one a second sub-video image according to a configuration type of the first display region;
sending the first sub-video image to the first timing control chip to instruct the first timing control chip to display the first sub-video image, and sending the second sub-video image to the second timing control chip to instruct the corresponding second timing control chip to display the second sub-video image,
wherein the first sub-video image is a sub-video image in odd columns, and the second sub-video image is a sub-video image in even columns,
wherein before the step of sending the first sub-video image to the first timing control chip and sending the second sub-video image to the second timing control chip, the method further comprises:
acquiring a first charging direction of a driving circuit of the display panel corresponding to the first sub-video image, and a second charging direction of a driving circuit of the display panel corresponding to the second sub-video image;
adjusting a grayscale value of pixels in the first sub-video image to a target grayscale value according to the first charging direction;
adjusting a grayscale value of pixels in the second sub-video image to a target grayscale value according to the second charging direction.

16. The liquid crystal display of claim 15, wherein after the step of splitting the first video image into the first sub-video image and the second sub-video image according to the configuration type of the first display region, the method further comprises:
determining a write-in address order of the first video image according to the configuration type of the first display region;
storing the first video image according to the write-in address order.

17. The liquid crystal display of claim 15, wherein before the step of sending the first sub-video image to the first timing control chip or the step of sending the second sub-video image to the second timing control chip, the method further comprises:
acquiring a first property parameter of the first sub-video image or the second sub-video image;
adjusting a property parameter of the first sub-video image or the second sub-video image, if the first property parameter is lower than a preset property parameter.

18. The liquid crystal display of claim 16, wherein before the step of sending the first sub-video image to the first timing control chip or the step of sending the second sub-video image to the second timing control chip, the method further comprises:
acquiring a first property parameter of the first sub-video image or the second sub-video image;
adjusting a property parameter of the first sub-video image or the second sub-video image, if the first property parameter is lower than a preset property parameter.

19. (canceled)

20. The liquid crystal display of claim 15, wherein the method further comprises:
receiving and acquiring a third sub-video image that is a video image, adjacent to the first video image, in a second video image of a second display region of the liquid crystal display panel;
determining a synchronization alignment parameter of a fourth sub-video image that is a video image in the first video image adjacent to the third sub-video image, according to the third sub-video image and the first video image;
processing the third sub-video image or the fourth sub-video image according to the synchronization alignment parameter to obtain a processed fourth sub-video image.
